(19) United States
(12) Patent Application Publication
(10) Pub. No.: US 2022/0318750 A1
(43) Pub. Date: Oct. 6, 2022

(54) METHOD FOR ROUTE PLANNING

(71) Applicant: Ford Global Technologies, LLC, Dearborn, MI (US)

(72) Inventors: Matus Banyay, Frechen (DE); Holger Mueller, Köln (DE)

(73) Assignee: Ford Global Technologies, LLC, Dearborn, MI (US)

(21) Appl. No.: 17/652,407

(22) Filed: Feb. 24, 2022

(30) Foreign Application Priority Data
Mar. 31, 2021 (DE) 102021108159.9

(51) Int. Cl. G06Q 10/08

(52) U.S. Cl. CPC G06Q 10/08355

(57) ABSTRACT

The invention relates to a method for route planning, with the steps: (S300) Reading in position data (PD) indicative of the stopping point of a recipient (E1, E2, E3) of a delivery, reading in duration data (ZD) indicative of a length of stay of a recipient (E1, E2, E3) at the stopping point, evaluating at least the position data (PD) and the duration data (ZD) by determining a value (W) indicative of a probability of encountering the recipient (E1, E2, E3) at the stopping point, taking into account the value (W) indicative of a probability of encountering the recipient (E1, E2, E3) at the stopping point when determining a route data record (FD), and outputting the route data record (FD).

### CROSS-REFERENCE TO RELATED APPLICATIONS

This application claims priority to and the benefit of German patent application No. DE 102021108159.9, filed Mar. 31, 2021, which is hereby incorporated by reference herein in its entirety.

### FIELD

The invention relates to a method for route planning.

### BACKGROUND

Route planning is a planning process in which transport orders are grouped into trips and placed in order. As a rule, a trip is carried out by a person and/or a motor vehicle. This planning process is important in all areas where a large number of orders and trips need to be planned. Examples include delivery from branches of a dealer or the delivery of parcels.

The objective of route planning is, for example, to minimize the number of motor vehicles used, the distance travelled, the operating time, the CO2 emissions or a more complex cost function.

Software for route planning supports the planning and optimization of such trips. For this purpose, the software requires as a data base inter alia a digital road network, a customer master file, a vehicle and driver list, and an up-to-date order list. Distances and travel times can be roughly estimated using coordinates of customer addresses or taken from a distance dataset, alternatively algorithms for route optimization operate on a digital road network. The optimization is carried out by summarizing the transport requirements of a number of customers into one or more trips in such a way that the time constraints of the customers, loads and capacities of the motor vehicles, break hours and working hours of the drivers and maintenance cycles of the motor vehicles are met, while the transport costs incurred are minimized.

It is also known to use dynamic destination coordinate data in route planning. These dynamic destination coordinate data come from mobile devices which a recipient of a delivery carries with them, such as smartphones. Thus, a changing location of the recipient can be taken into account in the route planning when determining a handover or delivery location. Such methods are known for example from U.S. Pat. No. 7,778,773 B2, US 2018/002532 A1 or US 2010/0217635 A1. However, such information about the handover or delivery location is inaccurate and unreliable. There is therefore a need to identify ways of achieving improvement here.

### SUMMARY

The object of the invention is achieved by a method for route planning, with the steps:

Reading position data indicative of the stopping point of a recipient of a delivery,

Reading duration data indicative of a time of stay of a recipient at the stopping point,

Evaluating at least the position data and the duration data by determining a value indicative of a probability of encountering the recipient at the stopping point,

Taking into account the value indicative of a probability of encountering the recipient at the stopping point when determining a route data record, and

Outputting the route data record.

Thus, at least position data and duration data relating to the recipient person, i.e. person-related data, are combined to determine a value indicative of a probability of encountering the recipient at the stopping point. If there are multiple stopping points to choose from, the stopping point can be selected which has the highest probability of an encounter.

By considering such a probability value, the management of time windows within which a recipient is to be encountered at a stopping point can be improved.

The route data record can be transferred, for example, to an HMI of a navigation device in a motor vehicle, such as a delivery vehicle, and output there to assist the driver of the motor vehicle in the delivery.

Thus, by determining and taking into account values for a probability of encountering the recipient at the stopping point, a route planning method can be improved.

According to one embodiment, during delivery according to the route data record, the method is carried out to dynamically update the route data record. Thus, the route data record is constantly checked and, if necessary, adjusted, especially if new position data and/or duration data are available.

According to another embodiment, the stopping point is a point of interest (POI). A point of interest (POI) is a point-by-point geo-object in connection with navigation systems and route planners, which could be of importance to a user of a navigation system. They can orientate themselves to meet their daily needs or deal with travel-specific needs, such as gastronomy, accommodation, petrol stations, ATMs or car parks. It can also be a point of contact in urgent situations, such as car repair workshops, pharmacies or hospitals, or they can be used for tourist attractions and leisure activities, including cinemas, sports stadiums, museums and other attractions. Thus, by assigning the point of interest, a length of stay can be estimated, depending on whether it is a petrol station, restaurant or ATM, for example.

According to another embodiment, the time duration data are determined on the basis of a movement pattern data record. For example, a movement pattern data record is obtained by recording and evaluating location data that originate from a mobile device, such as a smartphone, which the recipient carries with them. It is also possible to evaluate a route entered into a navigation app of a mobile device or into a navigation system of a motor vehicle. Thus, by evaluating such a movement pattern data record, typical stopping points can be determined together with a respective length of stay, additionally supplemented by for example time of day information about when a recipient arrives at the stopping point and leaves it again.

According to a further embodiment, data are read in from an IoT system and evaluated. An IoT system is an infrastructure that allows physical and virtual objects to be networked with each other and to work together through information and communication techniques. For example, machine-machine communication can be used to fuse data from multiple sources. For example, if a recipient is in a cinema, the time of an end of a film presentation can be determined, or if the recipient is in a restaurant, due to a payment process it can be concluded that he will leave the restaurant shortly.

Further, the invention includes a computer program product, a system for route planning and a motor vehicle with such a system. Wherein the system and/or the computer program is executed on a computer comprising memory and processor(s).

### BRIEF DESCRIPTION OF THE DRAWINGS

The invention will now be explained on the basis of a drawing. In the figures:

FIG. 1 shows in a schematic representation a system for route planning.

FIG. 2 shows in a schematic representation an excursion scenario for route planning with the system shown in FIG. 1.

FIG. 3 shows in a schematic representation a route determined with the system shown in FIG. 1.

FIG. 4 shows in a schematic representation a method for the operation of the system shown in FIG. 1.

### DETAILED DESCRIPTION

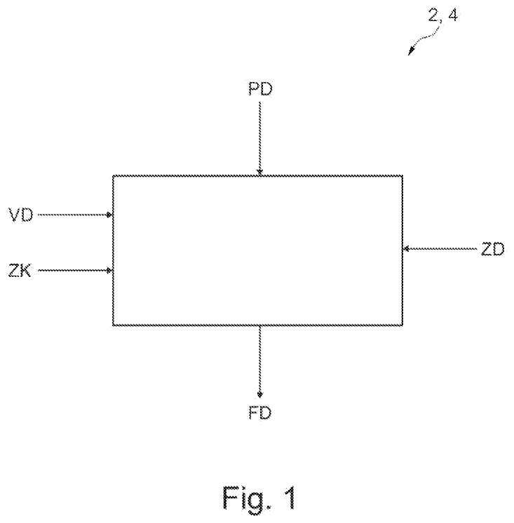

First of all, reference is made to FIG. 1.

A system 2 for route planning is illustrated.

The system 2 may be associated with a navigation device in a motor vehicle 4, such as a delivery vehicle. Alternatively, the system 2 may also have distributed components that are located in a logistics company center or hosted in a cloud, for example.

For the tasks and/or functions described below, the system 2 may have hardware and/or software components.

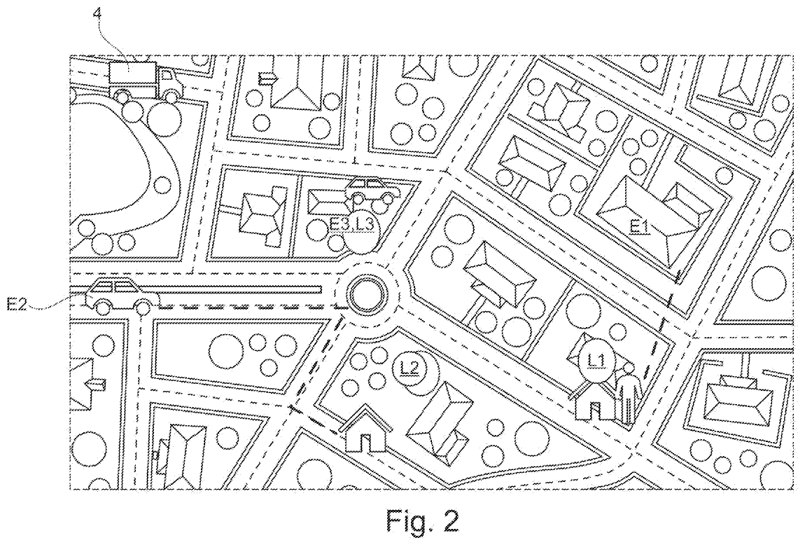

In the present exemplary embodiment, the system 2 is designed to read in via suitable interfaces static destination coordinate data ZK for each delivery stop L1, L2, L3 (see FIG. 2) for the respective recipients E1, E2, E3 (see also FIG. 2) and dynamic traffic management data VD, containing information about the current traffic situation, such as traffic jams, road closures, accidents, weather conditions, etc.

Furthermore, the system 2 is designed to read in via a suitable interface position data PD indicative of a stopping point of a recipient E1, E2, E3 of a delivery.

The position data PD can be obtained for example by evaluating location data coming from a mobile device, such as a smartphone, which the recipient E1, E2, E3 is carrying with him. In addition, the position data PD can be supplemented with time data.

Furthermore, the system 2 is designed to read in via a suitable interface time-duration data ZD indicative of a time of stay of the recipient E1, E2, E3 at the stopping point. The duration data ZD represent a prediction of how long a recipient will be stay a particular location.

The duration data ZD can be obtained by evaluating a so-called point of interest (POI). Thus, by assigning the point of interest to the current location of the recipient E1, E2, E3, a stopping time can be estimated, depending on whether it is a service station, restaurant or ATM, for example.

Furthermore, the duration data ZD can be determined on the basis of a movement pattern data record BD. The movement pattern data record BD is obtained for example by recording and evaluating location data coming from a mobile device, for example a smartphone, which the recipient E1, E2, E3 is carrying. Thus, by evaluating such a movement pattern data record BD typical stopping points together with a respective time of stay can be determined, additionally supplemented by for example time of day information regarding when the recipient E1, E2, E3 arrives at the stopping point and leaves it again.

Furthermore, data such as for example the position data PD and/or duration data ZD can be read in from an IoT system and evaluated. For example, machine-machine communication can be used to merge data from multiple sources, for example. For example, if the recipient E1, E2, E3 is in a cinema, the time of an end of a film presentation can be determined, or if the recipient E1, E2, E3 is in a restaurant, due to a payment process it can be concluded that he will leave the restaurant shortly.

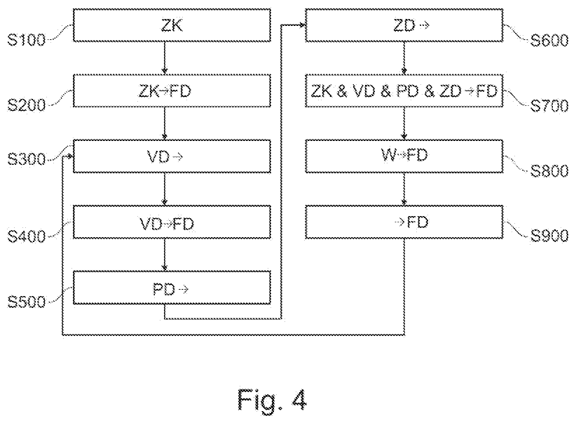

The system 2 is designed to evaluate the position data PD and the duration data ZD by determining a value W indicative of a probability (see FIG. 4) of encountering the recipient E1, E2, E3 at the stopping point.

Thus, a long predicted length of stay at a stopping point according to the duration data ZD leads to a high value W of the probability, i.e. it is to be considered probable that a delivery to the recipient E1, E2, E3 can take place here. In addition, the distance to this stopping point is also taken into account, i.e. the current position of the motor vehicle 4 and the position of the recipient E1, E2, E3 according to the position data PD, wherein a shorter distance also leads to a higher value W of the probability.

In other words, the position data PD and the duration data ZD are evaluated to create a statistical model for the behavior of the recipient E1, E2, E3 with which the duration data ZD are then produced for existing current position data PD and duration data.

If there are multiple stopping points to choose from, then the stopping point can be selected which has the highest value W for the probability of an encounter. Weighting factors can be used to take into account the length of a respective route. In this way, unnecessarily long routes can be avoided.

The location thus determined or predicted within a time window that is also determined or predicted is then taken into account in the route planning or adaptation of the route, which is then output as a route data record FD.

The route data record FD can be transferred for example to an HMI of a navigation device in the motor vehicle 2 and output there to assist the driver in the delivery.

Furthermore, the system 2 is designed to continuously update, i.e. dynamically update, during delivery according to the route data record FD as described above. Thus, changes in the stopping point of the recipient E1, E2, E3, in particular unexpected changes in the stopping point, which according to the values W for the probability are to be assessed as unlikely, may be taken into account.

Finally, the system 2 is designed to generate messages and send them to the recipient E1, E2, E3 to inform him of the handover point and period which are planned according to the route data record FD. These messages can be text and/or voice messages.

The system 2 can be designed for machine learning. In this case, machine learning means the automatic generation of knowledge from experience: such a system 2 learns from examples and can generalize these after the end of the learning phase. For this purpose, algorithms in machine learning build a statistical model based on training data. This means that patterns and laws are not simply memorized, but patterns and laws are recognized in the learning data. In this way, the system can also assess unknown data (learning transfer)

For this purpose, the system 2 may have at least one artificial neural net. Artificial neural nets, also known as artificial neural networks, are networks of artificial neurons. These neurons (also nodes) of an artificial neural network are arranged in layers and usually connected to each other in a fixed hierarchy. The neurons are usually connected between two layers, but in rarer cases they are also connected within one layer.

Such an artificial neural network is trained during a training phase before it is put into operation. During the training phase, the artificial neural network is modified so that it produces corresponding output patterns for certain input patterns. This can be carried out through monitored learning, unmonitored learning, empowering learning or stochastic learning. For example, by means of the method of error recirculation (backpropagation or even backpropagation of error) the artificial neural network learns by changing weighting factors of the artificial neurons of the artificial neural network in order to achieve the most reliable mapping of given input vectors to given output vectors. The use of a trained artificial neural network offers the advantage of benefiting from its ability to learn, its parallelism, its fault tolerance and robustness against disturbances.

Reference is now also made to FIG. 2.

A scenario of route planning is shown for the motor vehicle 4 with three recipients E1, E2, E3, i.e. with a respective delivery stop L1, L2, L3 for each of the recipients E1, E2, E3.

The system 2 initially reads in static destination coordinate data ZK for each delivery stop L1, L2, L3. The destination coordinate data ZK can be based for example on the address data of the respective recipients E1, E2, E3 or also on alternative location data.

In the present exemplary embodiment, the home of the first recipient E1 is provided for the first delivery stop L1 and the home of the second recipient E2 is provided for the second first delivery stop L2, while the respective location of the motor vehicle of the third recipient E3 is provided for the third delivery stop L3. In other words, in the present exemplary embodiment, the third recipient E3 has agreed to a trunk delivery, in which the delivery is temporarily stored in the trunk of the motor vehicle which thus assumes the function of a parcel station.

Based on these static destination coordinate data ZK, the system 2 generates the route data record FD.

Furthermore, in the present exemplary embodiment the system 2 reads in the dynamic traffic management data VD.

On the basis of these dynamic traffic management data VK, the system 2 may modify the route data record FD.

However, this type of route planning can lead to the result that one or all recipients E1, E2, E3 are not encountered within the scope of the respective planned delivery stops L1, L2, L3 and therefore a corresponding delivery or handover of a consignment for example fails.

The result is a new delivery attempt on the following day and, if necessary, a return of the consignment.

In the present scenario, the delivery or handover of a consignment to the first recipient E1 failed, for example, because for example the first recipient E1 visits a certain guest establishment, such as a restaurant, for 1.5 hours every Friday evening. In the present exemplary embodiment it is therefore assumed that here the first recipient E1 is encountered with a probability of 95%.

Furthermore, in the present scenario, the delivery or handover of for example a consignment to the second recipient E2 failed, because according to his current location according to their smartphone the second recipient E2 was on his way home from his place of work, as revealed for example from an evaluation of his movement pattern data record BD. In the present exemplary embodiment it is therefore assumed that the recipient is encountered here with a probability of 99.9%. In addition, an analysis of the movement pattern data record BD revealed that the recipient left his residence on Friday evening after a short stay of 30 minutes. In the present exemplary embodiment it is therefore assumed that in a time window of 30 minutes the second recipient E2 is encountered here with a probability of 95%.

Furthermore, in the present scenario, the delivery or handover of a consignment to the third recipient E3 failed, for example because according to their current location according to the navigation system of their motor vehicle the third recipient E3 was located at a point of interest, such as a supermarket. An evaluation of his movement pattern data record BD revealed a stay of 30 minutes. In the present exemplary embodiment it is therefore assumed that in a time window of 10 minutes the third recipient E3 will be encountered here with a probability of 95%.

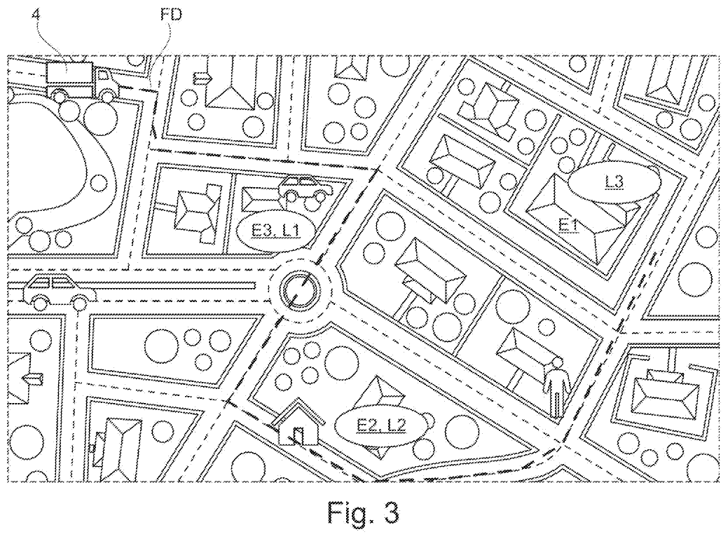

Reference is now also made to FIG. 3.

If one or all recipients E1, E2, E3 have given their consent via a suitable smartphone app, for example, that delivery or handover is also possible at alternative locations, the system 2 takes into account the respective values W indicative of a probability of an encounter of the respective recipient E1, E2, E3 at his current location when determining a route data record FD or modifies the already existing route data record FD before it is output.

In addition, the route data record FD is dynamically updated during the delivery.

In the present exemplary embodiment, for example after the evaluation of the static destination coordinate data ZK and the dynamic traffic management data VK of the route data record FD, it can be provided that first the first recipient E1 is visited at a first delivery stop L1, then the second recipient E2 is visited at a second delivery stop L2, and then the third recipient E3 is visited at a third delivery stop L3.

On the other hand, after the evaluation of the position data PD and the duration data ZD, it is provided in the present exemplary embodiment that first the third recipient E3 is visited at a first delivery stop L1, then the second recipient E2 is visited at a second delivery stop L2, and then the first recipient E1 is visited at a third delivery stop L3, because the third recipient E3 is probably still at the point of interest, the second recipient E2 has arrived at home in the meantime without having already left it again, and the first recipient E1 is still in the restaurant. In other words, instead of the residence of the first recipient E1, his current stopping is visited here. For this purpose, it may be provided to update the static destination coordinate data ZK accordingly, i.e. the delivery stop L3 is assigned a new destination address, for example by modified destination coordinate data ZK.

In other words, the route according to the route data record FD is optimized according to the greatest chances or probability of success. In addition, the length of the route, weighted by weighting factors, can be taken into account. As a result, the route may deviate from a shortest route according to the route data record FD.

Reference is now additionally made to FIG. 4 in order to explain a procedure for the operation of the system 2.

In a first step S100, the system 2 reads in the static destination coordinate data ZK for each delivery stop L1, L2, L3 for the respective recipients E1, E2, E3.

In a further step S200, the system 2 generates the route data record FD based on this static destination coordinate data ZK.

In a further step S300, in the present exemplary embodiment the system 2 reads in dynamic traffic management data VD.

In a further step S400, in the present exemplary embodiment the system 2 modifies the route data record FD.

In a further step S500, the system reads 2 in position data PD indicative of a stopping point of a recipient E1, E2, E3 of a delivery. In the present exemplary embodiment, the stopping point can be a point of interest (POI).

In a further step S600, the system 2 reads in duration data ZD indicative of a length of stay of a recipient E1, E2, E3 at the stopping point. The duration data ZD are determined in the present embodiment on the basis of the movement pattern data record BD. In addition, in the present exemplary embodiment data are read in from an IoF system and evaluated to determine the duration data ZD, for example.

In a further step S700, in the present exemplary embodiment the system 2 evaluates the static destination coordinate data ZK and the dynamic traffic management data VD as well as the position data PD and the duration data ZD to determine a value W indicative of a probability of an encounter with the recipient E1, E2, E3 at the stopping point.

In a step S800, the system 2 modifies the route data record FD again, taking into account the value W indicative of a probability of an encounter with the recipient E1, E2, E3 at the stopping point.

In a further step S900, the system 2 outputs the route data record FD. In the present exemplary embodiment, it is then transferred to an HMI of a navigation device in a motor vehicle, such as a delivery vehicle, and output there to assist the driver in the delivery.

During the delivery, the route data record FD is dynamically updated, for example by returning to step S300.

By way of deviation from the present exemplary embodiment, the order of the steps may also be different. In addition, multiple steps can also be performed at the same time or simultaneously. Furthermore, in contrast to the present exemplary embodiment, individual steps may be skipped or omitted.

Thus, by determining and taking into account values W for a probability of encountering the recipient at stopping point, a route planning method can be improved.

### REFERENCE CHARACTER LIST

2 System
4 Motor vehicle
BD Movement pattern data record
E1 Recipient
E2 Recipient
E3 Recipient
FD Route data record
L1 Delivery stop
L2 Delivery stop
L3 Delivery stop
PD Position Data
VD Dynamic traffic management data
W Value
ZD Duration Data
ZK Static destination coordinate data
S100 Step
S200 Step
S300 Step
S400 Step
S500 Step
S600 Step
S700 Step
S800 Step
S900 Step

That which is claimed is:

1. A method for route planning, with the steps:
(S300) reading in position data (PD) indicative of the stopping point of a recipient (E1, E2, E3) of a delivery,
reading in duration data (ZD) indicative of a length of stay of a recipient (E1, E2, E3) at the stopping point,
evaluating at least the position data (PD) and the duration data (ZD) by determining a value (W) indicative of a probability of encountering the recipient (E1, E2, E3) at the stopping point,
taking into account the value (W) indicative of a probability of encountering the recipient (E1, E2, E3) at the stopping point when determining a route data record (FD), and
outputting the route data record (FD).

2. The method according to claim 1, wherein during the delivery according to the route data record (FD) the method is carried out in order to dynamically update the route data record (FD).

3. The method according to claim 1, wherein the stopping point is a point of interest (POI).

4. The method according to claim 1, wherein the duration data (ZD) are determined on the basis of a movement pattern data record (BD).

5. The method according to claim 1, wherein data are read in from an IoF system and evaluated.

6. A computer program product, designed to perform the method according to claim 1.

7. A system (2) for route planning, the system comprising:
memory coupled to a processor, wherein the processor is configured to read in position data (PD) indicative of a stopping point of a recipient (E1, E2, E3) of a delivery, to read in duration data (ZD) indicative of a length of stay of a recipient (E1, E2, E3) at the stopping point, at least to evaluate the position data (PD) and the duration data (ZD) in order to determine a value (W) indicative of a probability of encountering the recipient (E1, E2, E3) at the stopping point, to take into account the value (W) indicative of a probability of encountering the recipient (E1, E2, E3) at the stopping point when determining a route data record (FD) and to output the route data record (FD).

8. The system (2) according to claim 7, wherein the system (2) is designed to carry out the method during the delivery according to the route data record (FD) in order to dynamically update the route data record (FD).

9. The system (2) according to claim 7, wherein the stopping point is a point of interest (POI).

10. The system (2) according to claim 7, wherein the system (2) is designed to determine the duration data (ZD) on the basis of a movement pattern data record (BD).

11. The system (2) according to claim 7, wherein the system (2) is designed to read in and evaluate data from an IoF system.

12. A motor vehicle (4) comprising the system (2) according to claim 7.
